(19) United States
(12) Patent Application Publication
(10) Pub. No.: US 2019/0122132 A1
(43) Pub. Date: Apr. 25, 2019

(54) METHOD AND SYSTEM FOR ENERGY CONSUMPTION PREDICTION

(71) Applicant: GRID4C, Tel Aviv (IL)

(72) Inventors: Noa RIMINI, Ra'anana (IL); Daniel ADRIAN, Jerusalem (IL)

(21) Appl. No.: 16/094,718

(22) PCT Filed: Apr. 18, 2017
(86) PCT No.: PCT/IL2017/050455

§ 371 Date: Oct. 18, 2018

Related U.S. Application Data
(60) Provisional application No. 62/324,440, filed on Apr. 19, 2016.

(51) Int. Cl. G06N 7/00; G06N 5/02; G06K 9/62; G06N 20/20; G06F 9/54

(52) U.S. Cl. CPC G06N 7/005; G06N 5/025; G06F 9/542; G06K 9/6256; G06N 20/20; G06N 5/022

(57) ABSTRACT

The present invention provides a method for identifying abnormalities in personal energy consumption/usage. The method comprising the steps of: generating personal dynamic forecast model of energy usage patterns in sub-hourly resolution for defined time periods, based on historical personal usage data considering environmental/weather condition (temp, humidity), wherein the dynamic model apply adaptive gradient boost iterative learning algorithm using predefined periodical features and determining abnormalities of actual energy usage in defined time period by comparing predictions of the forecast model, wherein the predictions are calculated by applying the generated forecast model with the actual environmental condition at the relevant time period and identifying delta between the actual usage and the predicted usage patterns which exceeds a predefined threshold for predefined duration.

### TECHNICAL FIELD

The present invention relates to the field of energy consumption prediction and more specifically to analyzing abnormalities in energy consumption and providing personal recommendations.

### BRIEF SUMMARY

The present invention provides a method for identifying abnormalities in personal energy consumption/usage. The method comprising the steps of: generating a personal dynamic forecast model of energy usage patterns in sub-hourly resolution for defined time periods, based on historical personal usage data considering environmental/weather condition (temperature, humidity), wherein the dynamic model applies an adaptive gradient boost iterative learning algorithm using predefined periodical features and determining abnormalities of actual energy usage in defined time period by comparing predictions of the forecast model, wherein the predictions are calculated by applying the generated forecast model with the actual environmental condition at the relevant time period and identifying the delta between the actual usage and the predicted usage patterns which exceeds a predefined threshold for predefined duration.

According to some embodiments, the present invention provides a method for identifying usage rules in personal energy consumption/usage. The method comprising the steps of: building regression-tree based historical usage data and actual environmental conditions, extracting the route leading to every leaf of the generated regression tree, and translating each route into range category and defining personalized usage behavior rules according to defined category ranges based on identified relevant route.

The present invention provides a method for identifying abnormalities in energy usage of households. The method implemented by one or more processors operatively coupled to a non-transitory computer readable storage device, on which are stored modules of instruction code that when executed cause the one or more processors to perform:
generating a dynamic forecast model per household of energy usage patterns in sub-hourly resolution for defined time periods, based on historical personal usage data considering environmental condition, wherein the dynamic model applies adaptive gradient boost iterative learning algorithm using explanatory periodical or environment dependent features;
determining abnormalities of actual energy usage in defined time period by comparing predictions of the forecast model, wherein the predictions are calculated by applying the generated forecast model with the actual environmental condition at the relevant time period and identifying delta between the actual usage and the predicted usage patterns which exceeds a predefined threshold for predefined duration.

According to some embodiments of the present invention the method further comprises the steps of:
comparing the identified delta in terms of the KWH usage and delta change along the time axis to an existing table of labeled household appliances normal KWH usage and change over time;
alerting users of appliance which are correlated with each abnormality based on comparison results at each relevant period.

According to some embodiments of the present invention, the method further comprises the steps of creating alerts of user personal abnormalities at predefined schedule and calculating the impact of the changes on the user's electricity bill.

According to some embodiments of the present invention, the method further includes the pre-processing of historical consumption usage for identifying usage pattern in sub-hourly resolution in relation to environment conditions. The identified usage pattern is used for identifying periodical features which provide more accurate forecasts.

According to some embodiment of the present invention the identification of usage patterns includes iterative running of a gradient boost algorithm on training data of historic consumption usage for identifying the explanatory periodical or environment dependent features which provides more accurate forecast results.

According to some embodiment of the present invention, the method further comprises the steps of dynamically updating forecast model based on the latest exceptional consumption data and environmental conditions, by applying a gradient boosting algorithm.

According to some embodiment of the present invention the method further comprises the steps of:
training a GBT regression model for estimating the expected (‘mean’) power consumption per each household;
training a GBT quantile regression model for estimating the upper bound of several percentile ranges, e.g.: the 90%, 95%, and 99% upper bounds;
Training several machine learning quantile regression models per each household, wherein each model estimates the probability of a specific percentile of power consumption, from that households' maximal power consumption;
determining as an abnormality any point at different time periods that exceeds any of the above percentiles and the predefined consumption threshold assigned for each percentile.

According to some embodiments of the present invention, the method further includes the step of estimating per each abnormality point its respective percentile for the sampled household consumption at the respective time, using mean or upper bounds, assuming normal distribution.

According to some embodiments of the present invention, the method further comprises the step of calculating the probability of each abnormality point, based on comparing power consumption of each point to the relevant percentile model.

According to some embodiments of the present invention, the method further comprises the steps of:
calculating the probability of each abnormality point based on comparing the power consumption of each point to the relevant percentile model;
in case the probability of one point or set of points is lower than predefined percentage, determining and reporting as collective anomalies and calculating delta of the collective anomalies;

According to some embodiment of the present invention, the method further comprises the step of applying a rule-based algorithm to identify appliances that are most probable in causing excess power consumption by comparing the properties of the identified delta to predefined entries in a table of respective power consumption properties of labeled household appliances.

According to some embodiments of the present invention the method further comprises the step of: emitting an alert to the user, in case at least one of the following occurs: the delta surpasses the said set of predefined thresholds, the user has shown a degree of responsiveness to receive such alert messages in the past and Alert time coincides with predefined alert schedules.

The present invention provides a method for identifying usage rules in personal energy consumption/usage. The method comprises the steps of:
building a regression trees based historical usage data and actual environmental conditions;
extracting the route leading to every leaf of the generated regression tree and translating each route into range category;
defining personalized usage behavior rules according to defined category ranges, based on identified relevant route.

The present invention provides a system for identifying abnormalities in energy usage of households, comprising a non-transitory computer readable storage device and one or more processors operatively coupled to the storage device on which are stored modules of instruction code executable by the one or more processors:
a forecast model generation engine for generating a dynamic forecast model per household of energy usage patterns in sub-hourly resolution for defined time periods, based on historical personal usage data considering environmental conditions, wherein the dynamic model applies an adaptive gradient boost iterative machine learning algorithm using predefined explanatory periodical or environment-dependent features;
an abnormalities analysis module for determining abnormalities of actual energy usage in defined time periods by comparing the predictions of the forecast model, with the actual power consumption, wherein the predictions are calculated by applying the generated forecast model with the actual environmental conditions at the relevant time period and identifying the difference (‘delta’) between the actual usage and the predicted usage patterns which exceeds a predefined threshold for predefined duration.

According to some embodiment of the present invention, the abnormalities analysis module further compares the identified delta in terms of the KWH usage and delta change along the time axis to an existing table of labeled household appliances normal KWH usage and change over time and alerts users of appliance which are correlated with each abnormality based on comparison of results at each relevant period.

According to some embodiment of the present invention the abnormalities analysis module creates alerts of user-specific power consumption abnormalities at a predefined schedule and calculate the impact of the changes on the user's electricity bill.

According to some embodiments of the present invention, the identified usage pattern is used for identifying explanatory periodical or environment-dependent features which provide more accurate forecasts.

According to some embodiment of the present invention, the forecast model generation engine further includes pre-processing of historical consumption usage for identifying usage patterns in sub-hourly resolution in relation to environment conditions wherein the identifying usage patterns include iterative running of a gradient boost algorithm on training data of historic consumption usage for identifying the explanatory periodical or environment-dependent features which provides more accurate forecast results;

According to some embodiment of the present invention, the forecast generating module dynamically updates the forecast model based on the latest exceptional power consumption data and environmental conditions, by applying a gradient boosting algorithm.

According to some embodiments of the present invention, the forecast generating module further applies the steps of:
training a GBT regression model for estimating the expected (‘mean’) power consumption per each household;
training several machine learning quantile regression models per each household, wherein each model estimates the probability of a specific percentile of power consumption, from that households' maximal power consumption; and
determining as an abnormality any point at different time periods that exceeds any of the above percentiles and the predefined consumption threshold assigned for each percentile.

According to some embodiment of the present invention the abnormalities analysis module further estimates per each abnormality point its respective percentile for the sampled household consumption at the respective time, using mean or upper bounds, assuming normal distribution.

According to some embodiment of the present invention, the abnormalities analysis module further calculates the probability of each abnormality point based on comparing power consumption of each point to the relevant percentile model.

According to some embodiment of the present invention, the abnormalities analysis module further comprises calculating the probability of each abnormality point based on comparing the power consumption of each point to the relevant percentile model. In case the probability of one point or set of points is lower than a predefined percentage, the abnormalities analysis module determines and reports as Collective anomalies and calculates the delta of the Collective anomalies.

According to some embodiment of the present invention, the abnormalities analysis module further applies a rule-based algorithm to identify appliances that are most probable in causing excess power consumption by comparing the properties of the identified delta to predefined entries in a table of respective power consumption properties of labeled household appliances.

According to some embodiment of the present invention, the abnormalities analysis module further emits an alert to the user, in case at least one of the following: the delta surpasses the said set of predefined thresholds, the user has shown a degree of responsiveness to receive such alert messages in the past and alert time coincides with predefined alert schedules.

### BRIEF DESCRIPTION OF THE DRAWINGS

The present invention will be more readily understood from the detailed description of embodiments thereof made in conjunction with the accompanying drawings of which:

FIG. 1 is a block diagram illustrating the components of the forecasting server and GUI platform at the user end according to some embodiments of the invention;

FIG. 2b is a flow chart illustrating the function of the Forecast model generation engine according to some embodiments of the invention;

FIG. 3 is a flow chart illustrating the function of the Abnormalities analysis module according to some embodiments of the invention;

FIG. 3B is a flow chart illustrating the function of the Abnormalities analysis module according to some embodiments of the invention.

FIG. 3C is a block diagram illustrating the function of the appliances abnormalities analysis overview according to some embodiments of the invention.

FIG. 3D is a flow chart illustrating the function of the appliances Abnormalities analysis module according to some embodiments of the invention.

FIG. 4 is an illustration the flow chart of the Usage behavior rules module according to some embodiments of the invention;

FIG. 5 is an illustration flow chart of the Pattern usage and abnormalities GUI module according to some embodiments of the invention;

FIGS. 6A and B are examples of the Pattern usage and abnormalities GUI according to some embodiments of the invention;

FIG. 7 is an illustration the flow chart of the Personal Recommendation GUI module according to some embodiments of the invention;

FIG. 8A is an example of the Personal Recommendation GUI messages according to some embodiments of the invention;

FIG. 8B is an example of the Pattern usage and abnormalities GUI for selected time period for specific recommendation message according to some embodiments of the invention;

FIG. 9 is an illustration the flow chart of the Personalized Behavior visualization rules GUI module according to some embodiments of the invention;

FIG. 10 is an example of the Personalized Behavior visualization rules GUI module according to some embodiments of the invention;

FIG. 11 is an illustration the flow chart of usage and cost forecast module according to some embodiments of the invention;

FIG. 12 is an example of usage and cost forecast GUI according to some embodiments of the invention;

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a predictive analytics machine learning engine for providing personal prediction of energy consumption per meter of an household or factory. The engine takes into account the historical load data at the residential customer level (per meter), together with historical weather information, and learns the usage patterns of each customer in various conditions (weather conditions, holidays, day of week, time of day etc.). Based on these usage pattern profiles, the actual usage behavior of the customer is monitored in order to automatically detect usage deviations. These deviations occur when a customer's electricity usage does not fit his regular usage pattern. The deviation in load consumption can, in many cases, be automatically disaggregated into the appliances that caused the deviation. Most of the time, deviations occur when a residential customer leaves an appliance operating by mistake, or utilizes the appliance differently. It can indicate, for example, that an air-conditioning system was not set properly, or that an appliance is not functioning well.

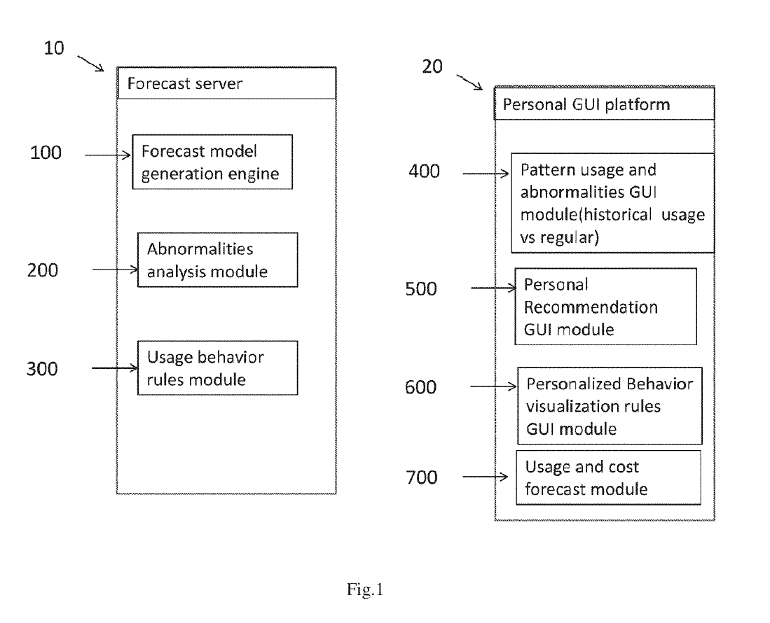

FIG. 1 is block diagram illustrating the components of forecasting server and GUI platform at the user end, according to some embodiments of the invention. The server according to the present invention includes a forecast model generation engine 100 for generating personalized consumption usage dynamic model per meter for households or factories. Based on running the model for the actual environmental/weather conditions compared to actual power consumption, are calculated abnormalities of usage patterns by the abnormalities analysis and recommendation module 200. According to some embodiments of the present invention it is suggested to provide a usage behavior rules module, for generating personal usage rules which describe consumption usage in terms of time schedule and weather conditions.

The GUI platform can be implemented as personal web-page or a designated application for tablet computers or Smartphones. The GUI platform includes at least one of the following:
A pattern usage and abnormalities GUI module 400, for presenting actual historical usage vs. regular usage indicating of abnormalities;
A personal Recommendation GUI module 500, for creating personal recommendation messages; and
A personalized Behavior visualization rules GUI module 600, for providing a textual description of personal usage consumption behavior in terms of defined usage rules and cost forecast module 700.

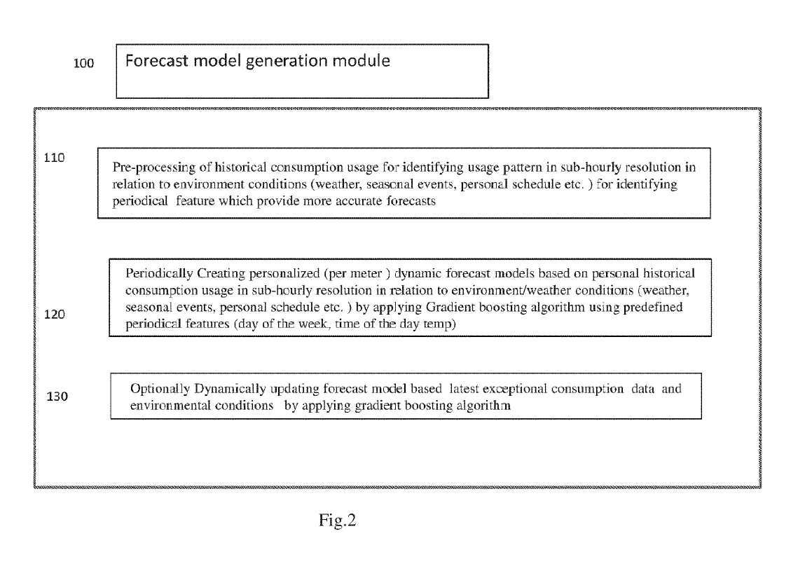

FIG. 2b is a flow chart depicting the function of the forecast model generation engine 100, according to some embodiments of the invention. The forecast model generation engine is henceforth referred to as the “Forecast module” for the purpose of abbreviation. The forecast module applies at least one of the following steps:
Pre-processing of historical consumption usage for identifying usage pattern in sub-hourly resolution in relation to environment conditions such as: weather conditions, seasonal events, personal schedule etc. The identified usage pattern is used for identifying explanatory periodical or environment-dependent features which provide more accurate forecasts. Pre-processing may include iterative running of a machine-learning gradient boosting algorithm on specific training data of historical consumption usage for identifying the technical parameters explanatory features, including environmental condition or periodical personal feature (e.g. activating the HVAC at a specific hour each day) which provides more accurate forecast results (step 110). The preprocessing phase enables to determine explanatory periodical or environment-dependent features and in what weight affect the user consumption (weather, day of the week, hour of the day, his previous day behavior).
Periodically creating personalized (per meter of household) dynamic forecast models based on personal historical consumption usage in sub-hourly resolution in relation to environment/weather conditions (weather, seasonal events, personal schedule etc.) by applying a gradient boosting algorithm using identified explanatory periodical or environment-dependent features, which define specific period or schedule/timing such as day of the week, time of the day or temp as were defined in the pre-processing stage. (step 120).
Optionally dynamically updating the forecast model based on the latest exceptional consumption data and environmental conditions, by applying a gradient boosting algorithm (step 130);
Training a GBT regression model for estimating the expected (‘mean’) power consumption per each household (step 140);
Training a GBT quantile regression model for estimating the upper bound of several percentile rages, e.g.: the 90%, 95%, and 99% upper bounds (step 150);
Training several machine learning quantile regression models per each household. Each such model estimates the probability of a specific percentile (e.g. 90%, 95%, 99%) of power consumption, from that households' maximal power consumption. (step 160);

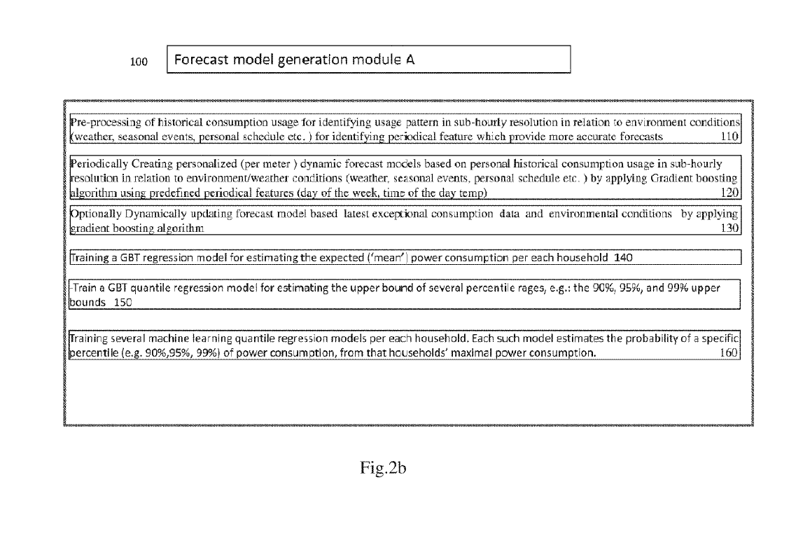

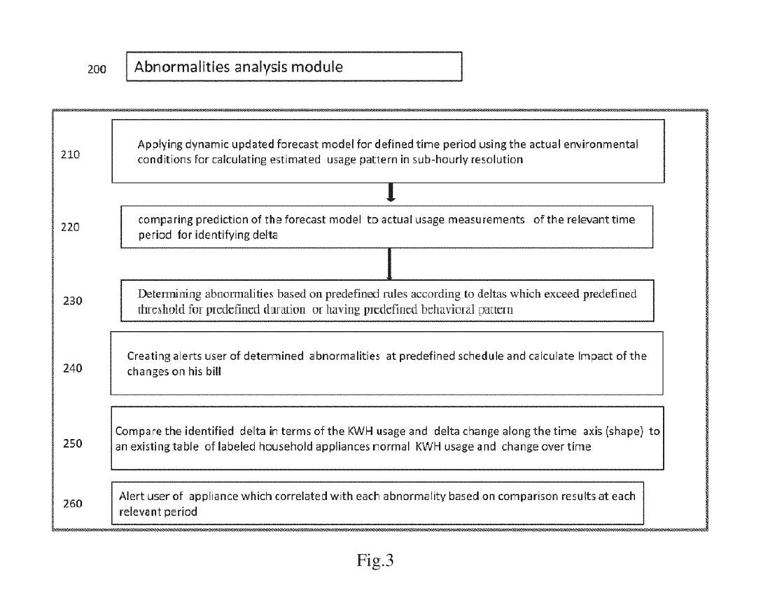

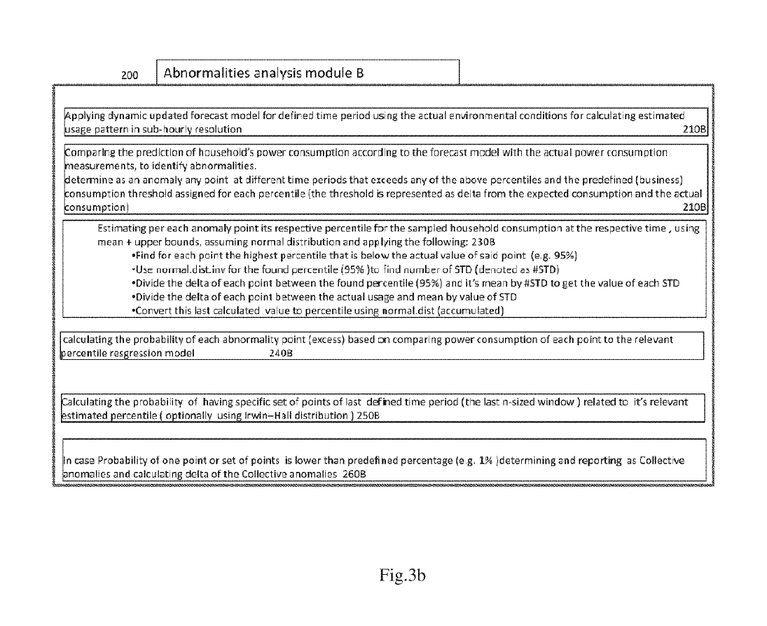

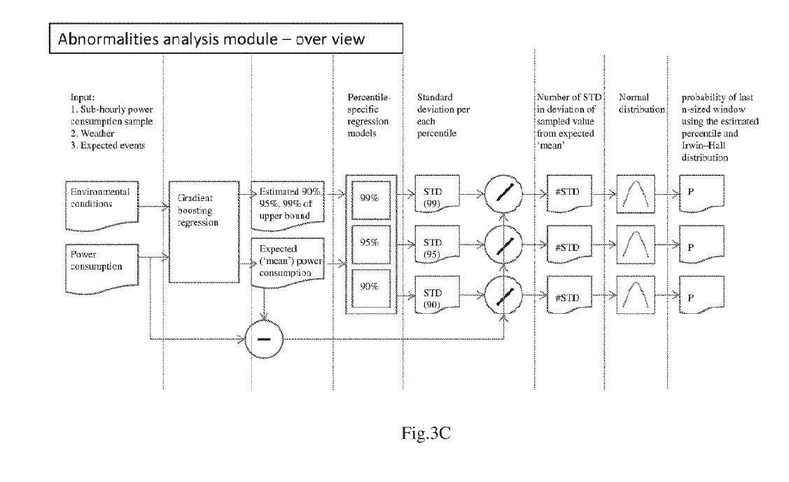

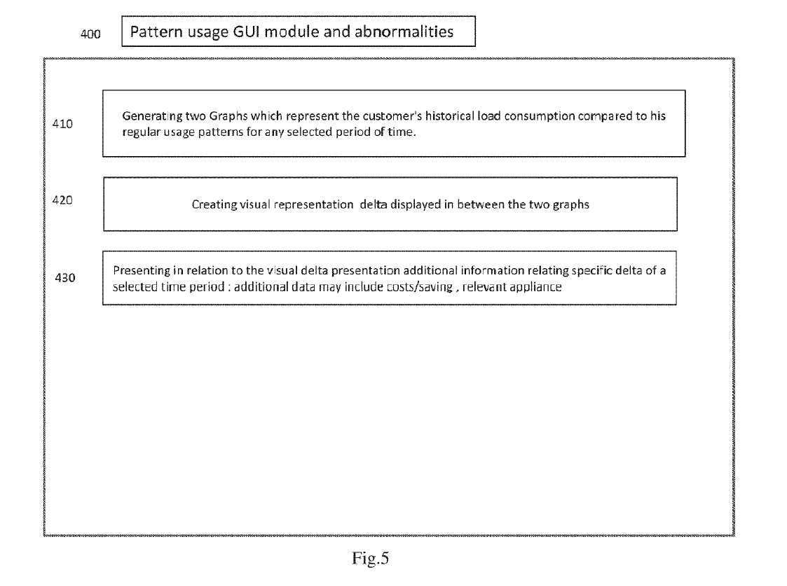

FIG. 3 is a flow chart illustrating the function of the abnormalities analysis module 200 according to some embodiments of the invention. The abnormalities analysis applies at least one of the following steps:
Applying the personal dynamic updated forecast model for defined time period using the actual environmental/weather conditions for calculating estimated usage pattern in sub-hourly resolution (step 210).
Comparing the predicted power consumption according to the forecast model to the actual power consumption measurements of the relevant time period for identifying the difference (‘delta’) between the two (step 220).
Determining abnormalities according to deltas which exceed predefined threshold for predefined duration or having predefined behavioral pattern (step 230).
Creating alerts of user personal power consumption abnormalities at predefined schedule and calculating the impact of the changes on the user's electricity bill (step 240).
Comparing the identified delta (difference) in terms of the KWH (Kilowatt*Hour) usage and delta change along the time axis (shape of delta of the graphs see FIG. 6A) to an existing table of labeled household appliances normal KWH usage and change over time (step 250).
Alerting users of appliances which are correlated with each abnormality based on the comparison results at each relevant period (step 260).

The personal recommendation messages may include actionable insights with valuable information to the customer. Whenever a significant deviation in a customer's electricity usage is detected, the module triggers an alert mechanism, which automatically produces a personalized recommendation message. The recommendation message includes at least one of the following:
Indications of changes in the user's personal consumption patterns, taking into account the weather conditions, holidays etc.;
Indications of the detected abnormality;
A suggestion of the correlated appliance involved; and
The detected abnormality's effect on the user's electricity bill.

FIG. 3B is a flow chart illustrating the function of the abnormalities analysis module 200 according to some embodiments of the invention. The abnormalities analysis module 200 applies at least one of the following steps:
Applying the personal dynamic updated forecast model for defined time period using the actual environmental/weather conditions for calculating estimated usage pattern in sub-hourly resolution (step 210A).
Comparing the prediction of households' power consumption according to the forecast model with the actual power consumption measurements, to identify abnormalities.
determining as an abnormality any point at different time periods that exceeds any of the above percentiles and the business consumption threshold assigned for each percentile (the threshold is represented as delta from the expected consumption and the actual consumption) (step 220 A);
Estimating per each abnormality point its respective percentile for the sampled household consumption at the respective time, using mean+upper bounds, assuming normal distribution and applying the following (step 230B):
   Find for each point the highest percentile that is below the actual value of said point (e.g. 95%);
   Use normal.dist.inv for the found percentile (95%) to find number of STD (denoted as #STD)
   Divide the delta of each point between the found percentile (95%) and it's mean by #STD to get the value of each STD
   Divide the delta of each point between the actual usage and mean by value of STD;
   Convert this last calculated value to percentile using normal.dist (accumulated);
Calculating the probability of each abnormality point (excess) based on comparing power consumption of each point to the relevant percentile model (step 240B);
Calculating the probability of having a specific set of points of last defined time period (the last n-sized window) related to it's relevant estimated percentile, optionally using Irwin-Hall distribution 250B
In case the probability of one point or set of points is lower than predefined percentage (e.g. 1%), determining and reporting the point or set of points as Collective anomalies and calculating the delta of the Collective anomalies (step 260B);

FIG. 3C is a block diagram illustrating the function of the appliances abnormalities analysis overview according to some embodiments of the invention.

FIG. 3D is a flow chart illustrating the function of the appliances abnormalities analysis module according to some embodiments of the invention. This analysis includes at least one of the following steps:
Comparing the delta to a set of predefined thresholds, such as:
   Duration of excess power consumption;
   Consistency of excess power consumption;
   Impact of excess power consumption on the user's electricity bill 210C.
Applying a rule-based algorithm to identify appliances that are most probable in causing excess power consumption. This is done by comparing the properties of the identified delta (e.g. duration, amplitude and change over time) to entries in a table of respective power consumption properties of labeled household appliances. For example: a dryer, which normally works for less than 3 consecutive hours is unlikely to cause excessive power consumption that spans over 8 hours. 220C;
Applying a disaggregation algorithm, incorporated in reference PCT/IL2017/050296 for determining the existence of specific appliances in the house, and the activation of the said appliances on the same day; (step 215C)
Applying a disaggregation algorithm, incorporated in reference PCT/IL2017/050296, to extract the relative percentage of power consumption per each appliance from the overall household's power consumption: 230C. On a daily disaggregation resolution, the algorithm includes:
   Extracting the daily contribution of each appliance to the household's power consumption
   Comparing the result to the customer peers and the customer history to try to establish which appliance is the outlier.

On an hourly disaggregation resolution, the probability of each appliance's concurrent operation during the anomaly period is calculated, further assisting to determine the outlier.
Emitting an alert to the user, if:
   The delta surpasses the said set of predefined thresholds;
   The user has shown a degree of responsiveness to receive such alert messages in the past; and
   Alert time coincides with predefined alert schedules.

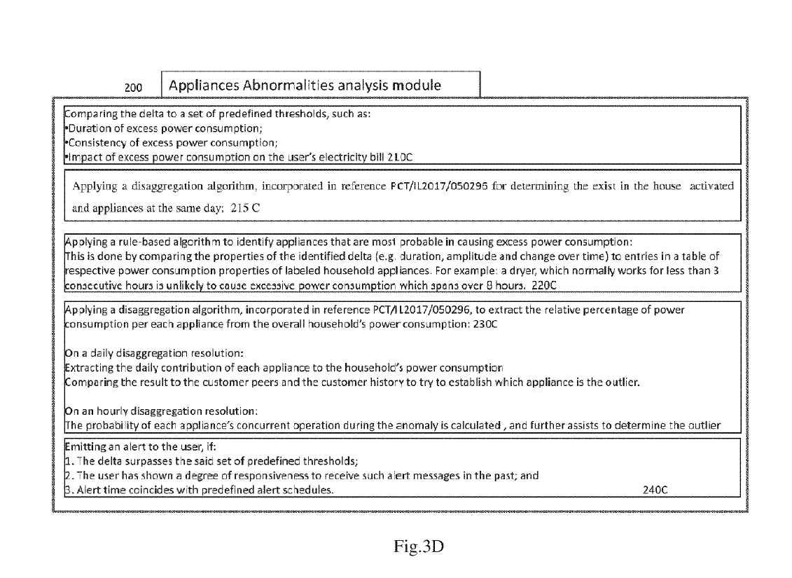

FIG. 4 is a flow chart illustrating the function of the usage behavior rules module, according to some embodiments of the invention.

A different algorithm is used for translating user's consumption behavior into consumption rules, that provide usage rules in relation to time schedule by separating in to weekdays and weekend rules, of ranges of: (1) days (2) hours (3 Each rule may consist) temperature, in which the user has a specific consumption behavior, and specify the usage average in these ranges, as well as the average costs.

The Usage behavior rules module applies the following algorithm:
building regression trees based on historical usage data and actual environmental conditions (step 310);
pruning the regression tree based on information theory pruning rules based on actual consumption (step 320).
extracting the route leading to every leaf of the generated regression tree and translating each route into a range of a specific category, such as the day of the week, the time of the day, or the temperature (step 330).
creating personalized usage behavior rules according to a defined category range (e.g.: day of the week, time of the day, temperature) based on the identified relevant route (step 340).

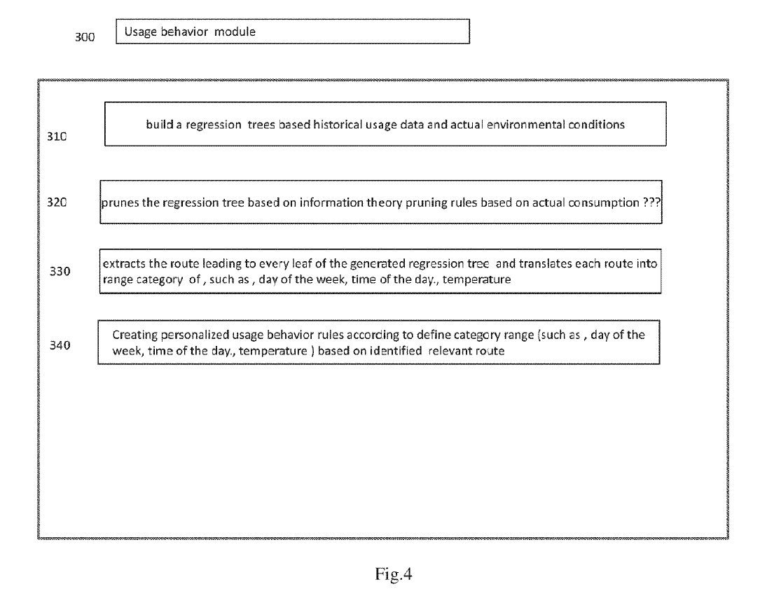

FIG. 5 is a flow chart illustrating the Pattern usage and abnormalities GUI module 400 according to some embodiments of the invention. The Pattern usage and abnormalities GUI module 400 includes at least one of the following steps:
Generating two graphs which represent the customer's historical load consumption compared to his regular usage patterns for any selected period of time, see example in FIG. 6 (step 410).
Creating a visual representation of the delta, displayed between the two graphs (step 420).
Presenting in relation to the visual delta presentation additional information, relating to specific delta of a selected time period. The said additional data may include costs/saving, and relevant appliance (step 430).

FIGS. 6A and 6B are examples of the Pattern usage and abnormalities GUI according to some embodiments of the invention. FIG. 6A presents a graph of the customer's actual historical power consumption compared to his regular usage patterns for any selected period of time. The delta between graphs is presented in colored areas in-between the graphs, over or under the regular consumption. In addition, the costs or savings for each period are also presented.

The message appearing at the top of the graph reflects the predicted usage patterns versus the actual consumption (i.e.: the delta data provided) in terms of cost.

FIG. 6B presents graphs of the actual usage and the usage patterns without marking the delta

The graph legend is clickable buttons that toggle the feature on or off.

The legend of each graph consists of:
A First line graph of the actual load usage.
A Second line graph of the predicted usage pattern.
When actual consumption use is higher than regular use, the delta between Actual use and Usage patterns is presented in first color areas between the graphs.
When actual usage is lower than the regular usage the delta between Actual and Usage patterns is presented in a second type of colored areas between the graphs.

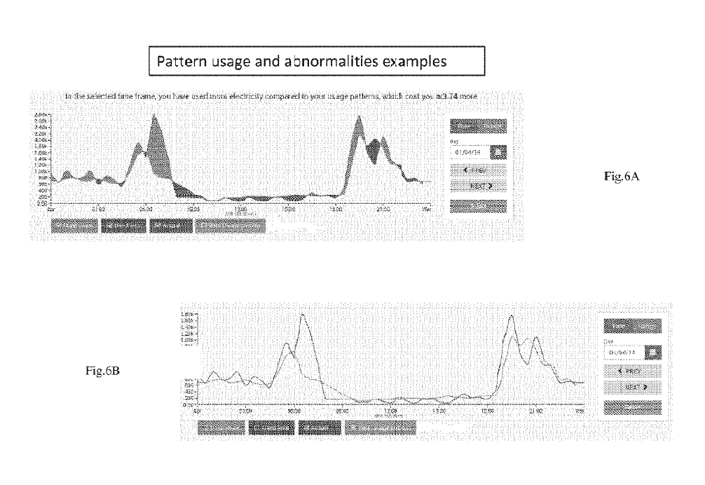

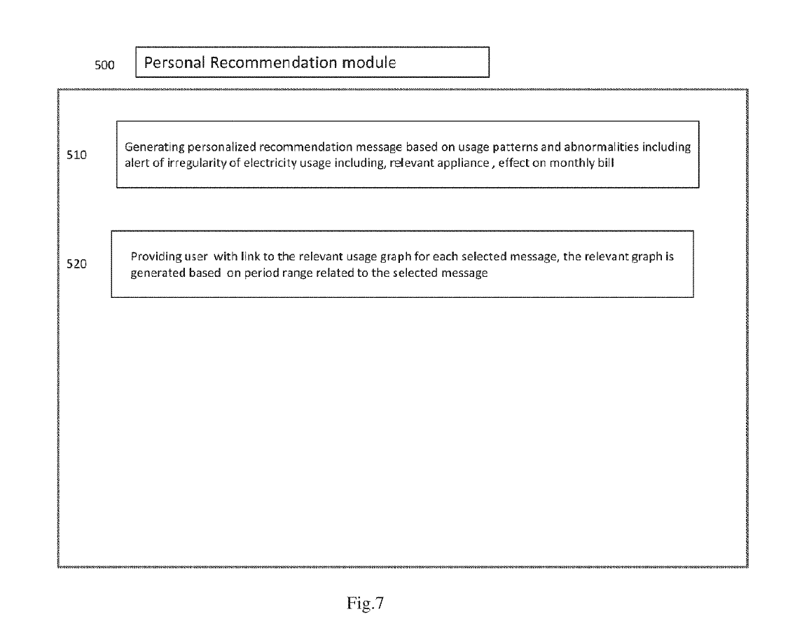

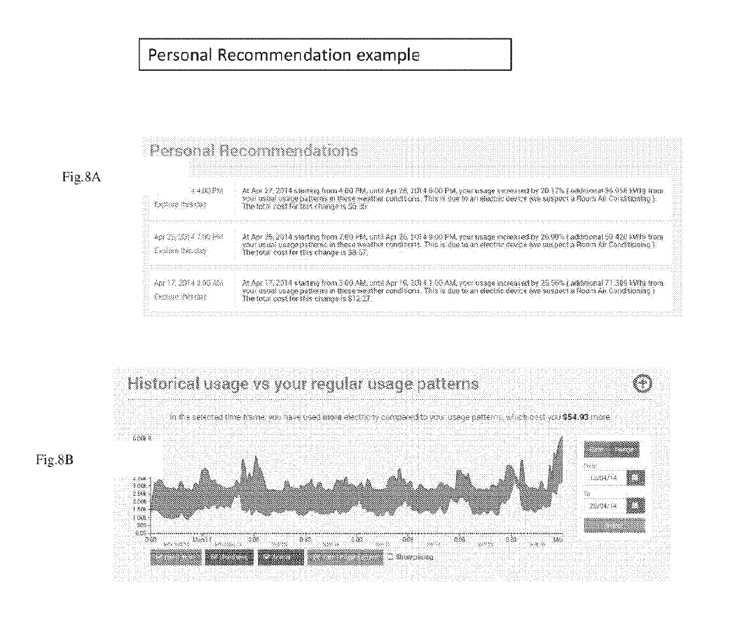

FIG. 7 is a flow chart illustrating the functionality of the Personal Recommendation GUI module 500 according to some embodiments of the invention. This module 500 applies the following actions:
It generates personalized recommendation messages based on usage patterns and abnormalities including alerts of irregular electricity usage, including the relevant appliance and the effect on the user's monthly electricity bill, see example in FIG. 8 (step 510).
It provides the user with a link to the relevant usage graph for each selected message. The relevant graph is generated in respect to the period reported in the selected message (step 520).

FIG. 8A is an example of a Personal Recommendation message, emitted by the Personal Recommendation GUI module 500 according to some embodiments of the invention.

FIG. 8B is an example of a Pattern usage and abnormalities message, emitted by the Pattern usage and abnormalities GUI module 400 in respect to a selected time period and specifically selected recommendation messages according to some embodiments of the invention.

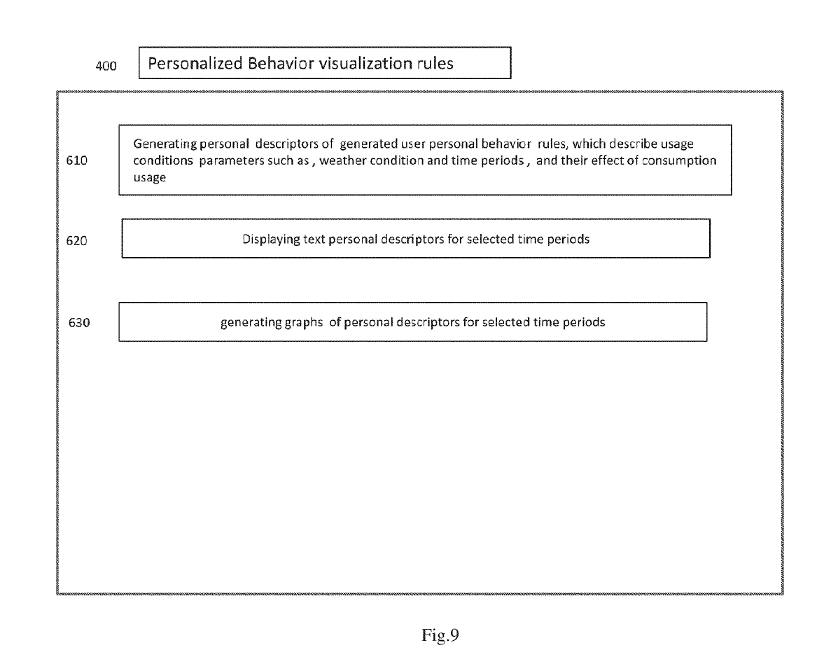

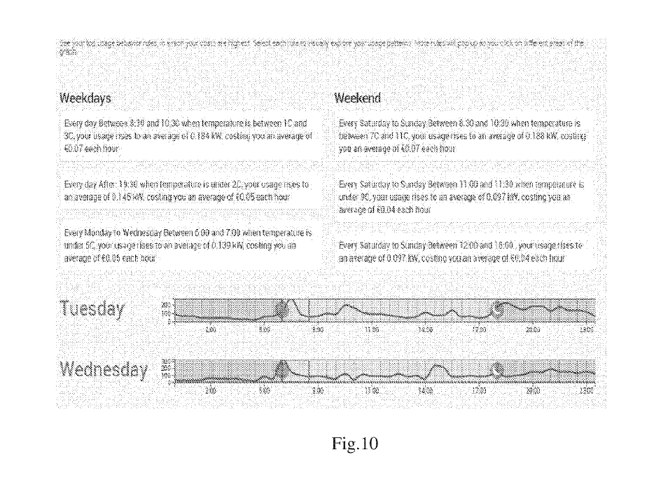

FIG. 9 is an illustration the flow chart of the Personalized Behavior visualization rules GUI module 400 according to some embodiments of the invention. This module 400 applies the following steps:
Generating a personal textual description of generated user personal behavior rules based on the generated personalized usage behavior rules, which describe usage conditions parameters such as weather conditions and time periods and their effect on power consumption usage, see example in FIG. 10 (step 610);
Displaying textual personal descriptions for selected time periods (step 620).
Generating graphs of personal textual description for selected time periods (step 630).

FIG. 10 is an example of the Personalized Behavior visualization rules GUI according to some embodiments of the invention.

This GUI provides the customer with a tool for exploring his personalized electricity usage behavior rules. Messages rule textual description includes usage consumption and costs in relation to weather condition and time schedule. When selecting each rule by clicking on the rule description, it is visually presented in an intuitive manner on a graph (as seen beneath the rules textual descriptions). More behavior rules may pop up when exploring the graph.

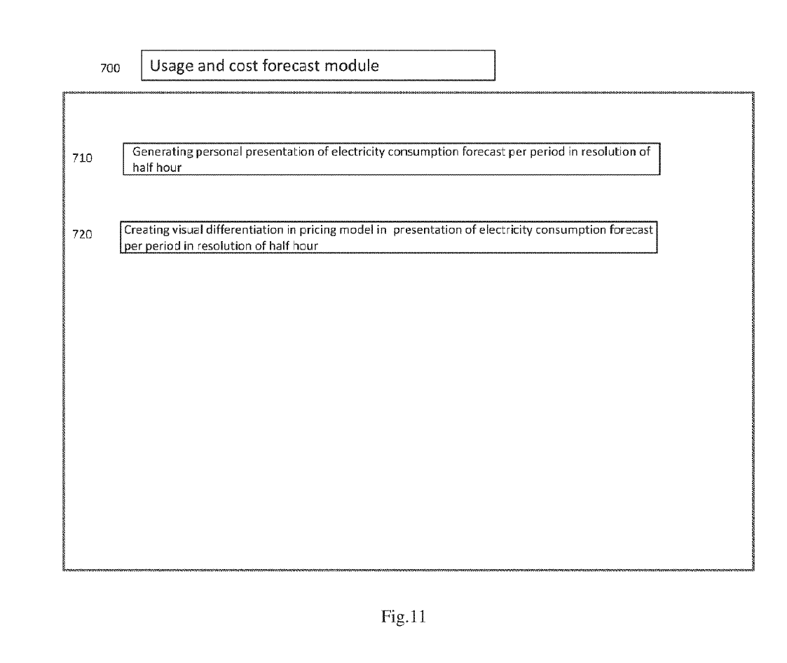

FIG. 11 is a flow chart illustrating the function of the usage and cost forecast module 700 according to some embodiments of the invention. This module 700 applies the following actions:
Generating personal presentation of a user's electricity consumption forecast per period in sub-hour (e.g. half-hour) resolution (step 710); and
Creating a visual differentiation in the pricing model in presentation of electricity consumption forecast per period in sub hour (e.g. half-hour) resolution (step 720).

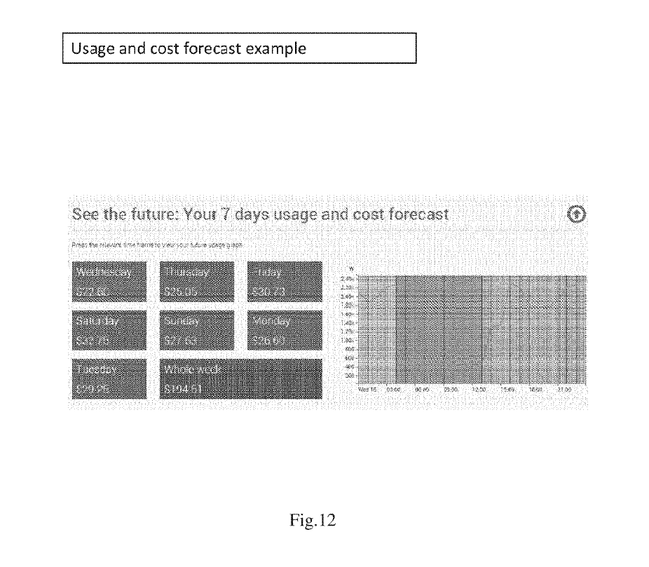

FIG. 12 is an example of the Usage and cost forecast GUI, according to some embodiments of the invention;

The left part of the GUI presents daily and weekly energy consumption cost forecasts.

At the right side of the GUI is presented a graph of usage consumption during a defined time period, in this example during a single day. The colors in the background represent a “time of use” electricity pricing model (in the demonstrated example there are 3 different price levels: background is red—when prices are high, green when prices are low, etc.).

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment. For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for identifying abnormalities in energy usage of household, said method implemented by one or more processors operatively coupled to a non-transitory computer readable storage device, on which are stored modules of instruction code that when executed cause the one or more processors to perform:
generating a dynamic forecast model per household of energy usage patterns in sub-hourly resolution for defined time periods, based on historical personal usage data considering environmental conditions, wherein the dynamic model applies an adaptive gradient-boost iterative machine-learning algorithm, using predefined explanatory periodical or environment-dependent features;
determining abnormalities of actual energy usage in defined time period by comparing predictions of the forecast model, wherein the predictions are calculated by applying the generated forecast model with the actual environmental condition at the relevant time period and identifying a delta between the actual usage and the predicted usage patterns which exceeds a predefined threshold for a predefined duration.

2. The method of claim 1, further comprising the steps of:
comparing the identified delta in terms of the KWH usage and delta change along the time axis to an existing table of labeled household appliances normal KWH usage and change over time;
alerting users of appliances which are correlated with each abnormality, based on the comparison results at each relevant period.

3. (canceled)

4. The method of claim 1 further comprising the step of pre-processing of historical power consumption usage for identifying usage pattern in sub-hourly resolution in relation to environmental conditions, wherein the identified usage pattern is used for identifying explanatory periodical or environment-dependent features which provide more accurate forecasts.

5. The method of claim 4 wherein identifying usage patterns includes iterative running of a gradient boost algorithm on training data of historic power consumption usage for identifying the explanatory periodical or environment-dependent features which provides more accurate forecast results.

6. The method of claim 1 further comprising the step of dynamically updating the forecast model based on the latest exceptional consumption data and environmental conditions, by applying a machine learning gradient boost algorithm.

7. The method of claim 1 further comprising the step of:
training a GBT regression model for estimating the expected (‘mean’) power consumption per each household;
training a GBT quantile regression model for estimating the upper bound of several percentile rages, e.g.: the 90%, 95%, and 99% upper bounds
training several machine learning quantile regression models per each household, each model estimates the probability of a specific percentile of power consumption, from that households' maximal power consumption
determining as an abnormality any point at different time periods that exceeds any of the above percentiles and the predefined consumption threshold assigned for each percentile.

8. The method of claim 30 further comprising the step of estimating per each abnormality point its respective percentile for the sampled household power consumption at the respective time, using the mean or upper bounds, assuming normal distribution.

9. The method of claim 8 further comprising the step of calculating the probability of each abnormality point, based on comparing the power consumption of each point to the relevant percentile model.

10. The method of claim 8 further comprising the step of:
calculating the probability of each abnormality point based on comparing the power consumption of each point to the relevant percentile model;
In case Probability of one point or set of points is lower than predefined percentage determining and reporting as collective anomalies and calculating delta of the collective anomalies

11. The method of claim 1 further applying a rule-based algorithm to identify appliances that are most probable in causing excess power consumption, by comparing the properties of the identified delta to predefined entries in a table of respective power consumption properties of labeled household appliances.

12. The method of claim 1 further comprising the step of emitting an alert to the user, in case at least one of the following: the delta surpasses the said set of predefined thresholds, the user has shown a degree of responsiveness to receive such alert messages in the past, and the alert time coincides with predefined alert schedules.

13. A method for identifying usage rules in personal energy consumption/usage, said method comprising the steps of:
building regression trees, based on historical usage data and actual environmental conditions;
identifying the route leading to every leaf of the generated regression tree and translating each route to a range category;
defining personalized usage behavior rules according to the defined category range based on the identified relevant route.

14. A system for identifying abnormalities in power consumption of households, comprising:
a non-transitory computer readable storage device and one or more processors operatively coupled to the storage device on which are stored modules of instruction code executable by the one or more processors;
a forecast model generation engine, configured to generate a dynamic forecast model per household of energy usage patterns in sub-hourly resolution, for defined time periods, based on historical personal usage data, considering environmental conditions, wherein the dynamic model applies an adaptive gradient boost iterative machine learning algorithm, using predefined explanatory periodical or environment dependent features;
an abnormalities analysis module configured to determining abnormalities of actual energy usage in a defined time period by comparing predictions of the forecast model, wherein the predictions are calculated by applying the generated forecast model with the actual environmental conditions at the relevant time period, and identifying the delta between the actual usage and the predicted usage patterns which exceeds a predefined threshold for a predefined duration.

15. The system of claim 14, wherein the abnormalities analysis module further compares the identified delta in terms of the KWH usage and delta change along the time axis to an existing table of labeled household appliances' normal KWH usage and change over time, and alert users of appliances which are correlated with each abnormality, based on the comparison results at each relevant period.

16. The system of claim 14 wherein the forecast model generation engine further includes the pre-processing of historical consumption usage for identifying usage patterns in sub-hourly resolution, in relation to environmental conditions, wherein the identified usage pattern is used for identifying periodical features which provide more accurate forecasts.

17. The system of claim 16 wherein the identification of power consumption patterns include iterative running of a gradient boost algorithm on training data of historic consumption usage for identifying the explanatory periodical or environment-dependent features, which provides more accurate forecast results.

18. The system of claim 14, wherein the forecast generating module comprises dynamically updating the forecast model, based on the latest exceptional consumption data and environmental conditions, by applying a gradient boost algorithm.

19. The system of claim 14 wherein the forecast generating module further comprises
training a GBT regression model for estimating the expected (‘mean’) power consumption per each household;
training of several machine learning quantile regression models per each household, each model estimating the probability of a specific percentile of power consumption, from that households' maximal power consumption and
determining as an abnormality any point at different time periods that exceeds any of the above percentiles and the predefined consumption threshold assigned for each percentile.

20-21. (canceled)

22. The system of claim 20, wherein the abnormalities analysis module further comprises calculating the probability of each abnormality point based on comparing the power consumption of each point to the relevant percentile model, wherein in case the probability of one point or set of points is lower than a predefined percentage, determining and reporting as Collective anomalies and calculating delta of the Collective anomalies.

23. The system of claim 14, wherein the abnormalities analysis module further comprises applying a rule-based algorithm to identify appliances that are most probable in causing excess power consumption by comparing the properties of the identified delta to predefined entries in a table of respective power consumption properties of labeled household appliances.

24. (canceled)
